(19) United States
(12) Patent Application Publication
(10) Pub. No.: US 2012/0272077 A1
(43) Pub. Date: Oct. 25, 2012

(54) GPS INPUT FOR POWER CONSUMPTION POLICY

(75) Inventors: Eli M. Dow, Poughkeepsie, NY (US); Marie R. Laser, Poughkeepsie, NY (US); Sarah J. Sheppard, Poughkeepsie, NY (US); Jessie Yu, Wappingers Falls, NY (US)

(73) Assignee: INTERNATIONAL BUSINESS MACHINES CORPORATION, Armonk, NY (US)

(21) Appl. No.: 13/091,846

(22) Filed: Apr. 21, 2011

(51) Int. Cl. G06F 1/26

(52) U.S. Cl. 713/310

(57) ABSTRACT

A portable computing device is provided. The portable computing device includes a power source for providing a power supply in accordance with a power consumption policy, a processing unit operably coupled to the power source and a storage unit. The storage unit is operably coupled to the power source and the processing unit and configured to cause the processing unit to access geo-location data and to adjust the power consumption policy based on the geo-location data.

### BACKGROUND

The present invention relates to power consumption policy and, more specifically, to a global position system (GPS) input for power consumption policy.

Laptops and other portable devices (such as cell phones, netbooks, etc.) typically include a rechargeable battery from which power can be drawn for computing operations when the devices are not plugged into a charging location. These rechargeable batteries may have between 3-8 hrs of life on a single charge depending on the type of battery and the type of computing being done. For example, if the devices are being used for high power demand activities, such as burning DVDs, the battery life could be shortened whereas, if the devices are simply idling or being used solely to read a document, which is already loaded into memory and need not be retrieved from rotational media, the battery life could be lengthened.

A power consumption policy governs an amount of power reserved for given computing operations and can determine whether insufficient power is available for given operations in the rechargeable battery. If it is determined that there is insufficient power in the rechargeable battery, a power consumption policy may refuse the operation, delay the operation or issue a low power warning to the user. Thus, it is seen that a good or efficient power consumption policy can provide a benefit to a user of the device.

### SUMMARY

According to an aspect of the present invention, a portable computing device is provided. The portable computing device includes a power source for providing a power supply in accordance with a power consumption policy, a processing unit operably coupled to the power source and a storage unit. The storage unit is operably coupled to the power source and the processing unit and configured to cause the processing unit to access geo-location data and to adjust the power consumption policy based on the geo-location data.

According to another aspect of the present invention, a method of managing a power consumption policy of a portable computing device is provided. The method includes determining an amount of available power, obtaining from geo-location data at least one of a proximity of the computing device to a charging location and an amount of time expected for the computing device to reach a charging location and adjusting the power consumption policy. The adjusting is responsive to the determined available power and at least one of the proximity of the computing device to a charging location and the expected amount of time for the computing device to reach a charging location.

According to yet another aspect of the present invention, a computer program product for managing a power consumption policy of a portable computing device is provided. The computer program product includes a tangible storage medium readable by a processing circuit and storing instructions for execution, by the processing circuit, a method. The method includes determining an amount of available power, obtaining from geo-location data at least one of a proximity of the computing device to a charging location and an amount of time expected for the computing device to reach a charging location and adjusting the power consumption policy. The adjusting is responsive to the determined available power and at least one of the proximity of the computing device to a charging location and the expected amount of time for the computing device to reach a charging location.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic illustration of a computing environment in which a portable computing device is deployed;

FIG. 2 is a schematic illustration of a portable computing device; and

FIG. 3 is a flow diagram illustrating an operation of a portable computing device.

### DETAILED DESCRIPTION

In accordance with aspects of the invention, geo-location data is used to adjust power usage dynamically and as a hint as to which networking location to connect to.

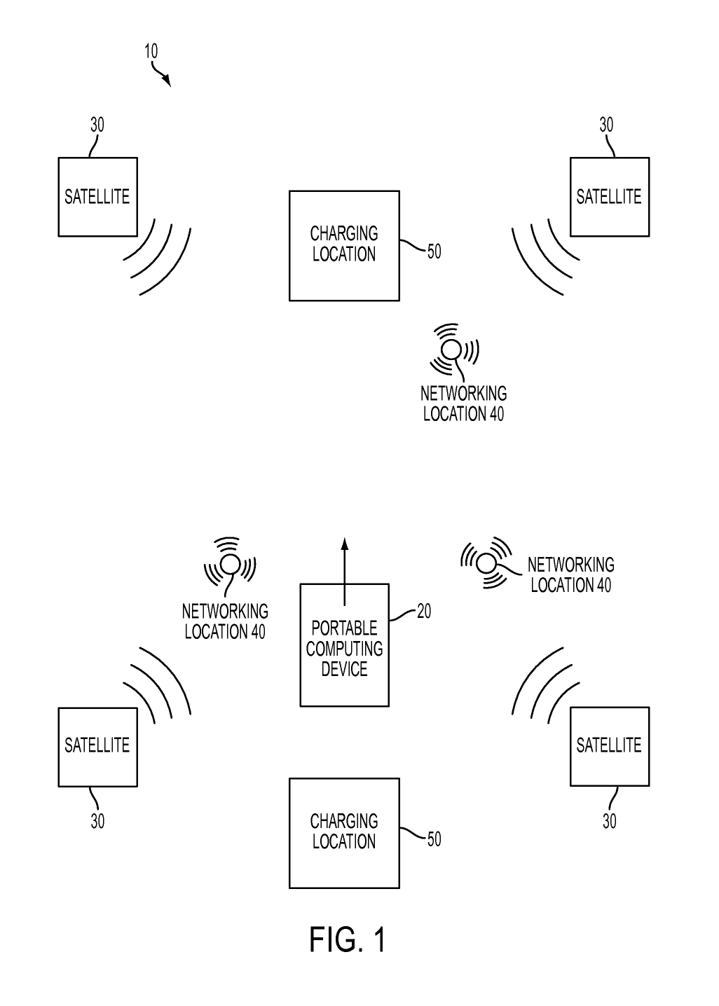

With reference now to FIG. 1, a system 10 is provided and includes a portable computing device 20. The system 10 further includes a plurality of satellites 30 serving a positioning system according to known methods and devices. The positioning system may be a global positioning system (GPS) or another type of positioning system, such as triangulated wifi access points or cell tower beacons where a database of such access points/towers and their geographic location is available. For clarity and brevity, the exemplary embodiment of the GPS will be described herein.

The portable computing device 20 may have access to the GPS to receive geo-location data. The system 10 further includes networking locations 40 and charging locations 50. The networking locations 40 can be any type of networking location, such as a local area network (LAN), a wide area network (WAN), a wifi hotspot or a similar type of location where the portable computing device 20 can access any one or more of various communications networks, such as the Internet. Any one or more of the networking locations 40 can also be communicative with any one or more of the satellites 30 to receive and to transmit to the portable computing device 20 the geo-location data. Thus, the portable computing device 20 can receive the geo-location data from either the satellites 30 themselves or the networking locations 40. The charging locations 50 can be any locations where the portable computing device 20 can be plugged into a power source for recharging.

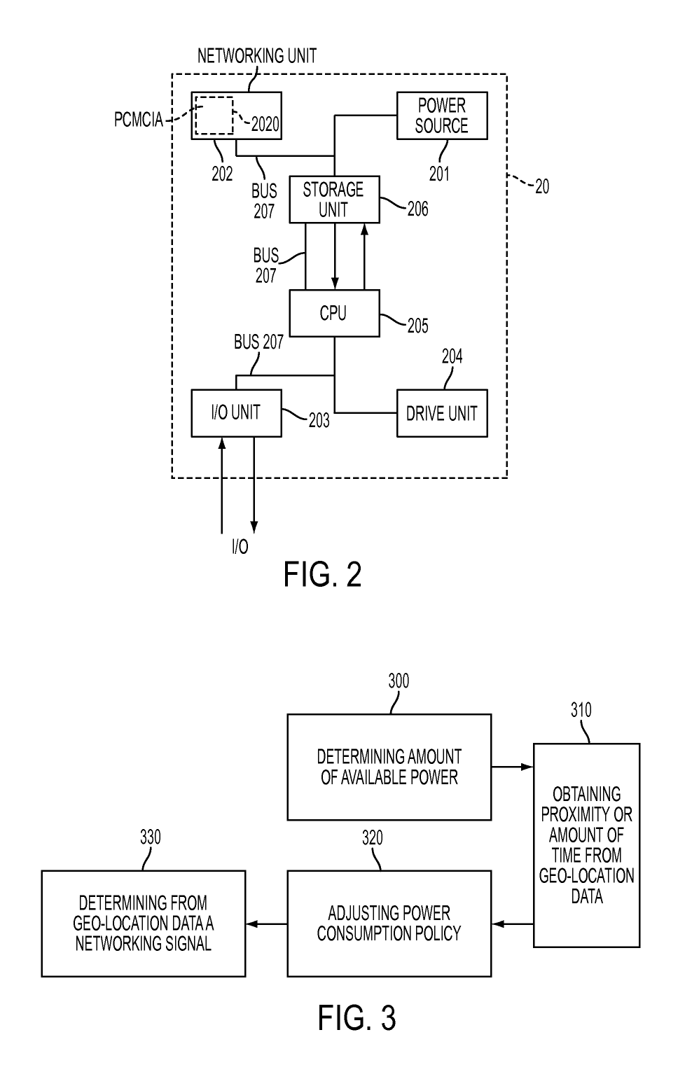

With reference to FIG. 2, the portable computing device 20 may be a laptop computer, a personal digital assistant, a smart phone or any similar type of computing device. As a general matter, the portable computing device 20 includes a power source 201. The power source 201 may be a rechargeable battery housed within the portable computing device 20. The power source 201 provides a limited remaining power supply to the portable computing device 20 as a whole in accordance with a power consumption policy. The power source 201 generally provides this power supply when the portable computing device 20 is not plugged into a charging location 50. When the portable computing device 20 is plugged into the charging location 50, the charging location 50 may provide the power supply to the portable computing device 20 directly.

The extent of the remaining power supply may vary from device to device in accordance with a type and capacity of the rechargeable battery, in accordance with a charge level of the portable computing device 20 when it was unplugged and in accordance with a type of computing being undertaken. This charge level will normally be expressed to the user of the portable computing device 20 as an icon showing remaining battery life and/or warnings that the battery life is nearly ended. The power consumption policy governs the amount of power allocated to various tasks, the type of computing jobs that can be handled based on the available power supply and normally makes determinations as to whether a given job can be handled at a given amount of available power subject to the disclosure provided herein.

The portable computing device 20 further includes a networking unit 202 by which the portable computing device 20 communicates with the satellites 30 and/or the networking locations 40, an input/output (I/O) unit 203, such as a touchpad or a mouse, a drive unit 204, such as a hard disk drive (HDD) and/or a DVD drive, and a processing circuit or unit 205, such as a central processing unit (CPU) or a microprocessor. The portable computing device 20 also includes a tangible storage medium or unit 206 and, for example, a bus 207, such as a universal serial bus, by which each of the components discussed herein are operably coupled to one another.

The networking unit 202 may include a built-in GPS device 2020, such as a Personal Computer Memory Card International Association (PCMCIA) GPS transponder, which communicates with the satellites 30 directly to receive the geo-location data. The networking unit 202 may also include a universal serial bus stick GPS receiver. Alternatively, the networking unit 202 may receive the geo-location data from the networking locations 40, which act as proximal GPS enabled devices, via wired or wireless protocols, such as wifi networks or Bluetooth enabled devices.

The storage unit 206 may be embodied as a computer or machine readable medium having executable instructions stored thereon. When executed, the executable instructions cause the processing unit 205 to access via the bus 207 the geo-location data as received by the networking unit 202 from the satellites 30 or the networking locations 40. When executed, the executable instructions further cause the processing unit 205 to adjust the power consumption policy based on the geo-location data. The adjustment of the power consumption policy can be achieved in multiple ways, a few non-limiting examples of which will be discussed below. When executed, the executable instructions may still further cause the processing unit 205 to access the geo-location data and to determine from the geo-location data a networking signal to connect to. That is, the portable computing device 20 may use geo-location data to ascertain which if any surrounding networks it can and should connect to.

In accordance with various embodiments, the adjustment of the power consumption policy by the processing unit 205 is preceded by an initial determination as to the remaining power available in the power source 201. That is, if the portable computing device 20 has been recently unplugged from a charging station 50 and has a full charge with a battery life of, for example, 3 hours, a normal power consumption policy may be invoked whereby all computing operations are possible and all jobs are accepted. By contrast, if it is expected that the battery life is about to end within, for example, 5 minutes or less, the processing unit 205 will begin to consider whether adjustments to the power consumption policy may need to be made.

The adjustments can be based upon types of computing operations to be conducted, the expected power demands of computing operations to be conducted and/or the expected power demands of newly requested jobs. That is, if limited power resources are available for high and low priority computing operations, such as maintaining a currently running business application with the processing unit 205 and burning a DVD with the drive unit 204, respectively, the processing unit 205 may delay the low priority computing operations in favor of the high priority computing operations at least until an amount of the available power in the power source 201 is increased. Meanwhile, if similar types of computing operations are to be conducted but one has an expected power demand that can be met by the available power and the other does not or one entered a processing queue earlier than the other, the processing unit 205 may elect to conduct the achievable/earlier queued computing operations in favor of the non-achievable/later queued computing operations, subject to parallel determinations that the elections will not have ancillary negative effects. In accordance with further embodiments, the adjustments can be based upon a determination that similar computing operations can be conducted at high power demand levels and low power demand levels whereby, if insufficient power is expected to be available for high power demand level computing operations, those same computing operations can be run at low power demand levels.

The adjustments can be further based on a determination by the processing unit 205 that a charging location 50, at which the portable computing device can be plugged into a power source for recharging, is relatively nearby. In this case, the processing unit 205 may be configured to monitor locations of, for example, prior charging locations and to identify from the geo-location data when the portable computing device 20 is within a predefined distance or near those prior charging locations. For the purposes of the present disclosure, the terms “predefined distance” and/or “near” may be synonymous with similar terms, such as “proximal,” “close” and “local,” and can be defined in accordance with the determined amount of remaining available power in the power source 201. That is, where the remaining amount of available power is large (i.e., 1 hour or more), nearby charging locations may be defined as relatively close or far away. By contrast, where the remaining amount of available power is small (i.e., 5 minutes or less), nearby charging locations may be defined only as relatively close by such that they can be accessed in a short time.

In the former case, the processing unit 205 may determine that little to no changes need to be made to the power consumption policy. However, in the latter case, where the remaining amount of available power is small, the processing unit 205 will determine whether the portable computing device 20 is near a charging location 50 and make adjustments to the power consumption policy accordingly.

For example, if a charging location is nearby and can be accessed before the amount of remaining available power is exhausted without delaying, canceling or postponing any computing operations to be conducted, the processing unit 205 will not adjust the power consumption policy to a significant degree. As another alternative example, if a charging location is not nearby and cannot be accessed before the amount of remaining available power is exhausted without delaying, canceling or postponing a significant number of computing operations to be conducted, the processing unit 205 will adjust the power consumption policy to possibly extend battery life or, where that is not possible, simply go into sleep mode perhaps ahead of time so as to avoid beginning a computing operation that cannot be completed prior to battery life being exhausted. Entering sleep mode in this manner may substantially extend the battery life until recharging is commenced. As yet another example, if a charging location is nearby but cannot be accessed before the amount of remaining available power is exhausted without delaying, canceling or postponing at least some computing operations to be conducted, the processing unit 205 will adjust the power consumption policy to possibly extend battery life. Here, the processing unit 205 may adjust the power consumption policy such that only high priority computing operations are undertaken or such that only low power demand computing operations are conducted or, where computing operations can be conducted at high or low power demand levels, such that computing operations be conducted at only low power demand levels.

In accordance with additional embodiments, it is to be understood that the geo-location data may indicate that the portable computing device 20 is moving toward or away from charging locations 50 at a given speed. In these cases, the processing unit 205 may additionally use the geo-location data to gauge the speed the portable computing device is moving and, based on the gauged speed, the processing unit 205 may further determine whether a charging location or whether multiple charging locations will be reached within a predefined time based on that speed. Here, again, the term “predefined time” may be synonymous with similar terms, such as “soon” and “shortly,” and can be defined in accordance with the determined amount of remaining available power in the power source 201.

In accordance with further embodiments, if multiple known charging locations are within traveling distance at the current rate of speed and direction of mobility, the processing unit 205 may also adjust the power consumption policy by boost a power rating or otherwise increasing power consumption to a theoretical maximum computational throughput power. By contrast, if only one charging location is nearby, the processing unit 205 may only unlock 85% of the theoretical maximum computational throughput power.

In accordance with further aspects of the invention and, with reference to FIG. 3, a method of managing a power consumption policy of a portable computing device 20 is provided. As shown in FIG. 3, the method includes determining an amount of available power in a power source 201 (300), obtaining from geo-location data a proximity of the computing device 20 to a charging location 50 or obtaining from the geo-location data an amount of time expected for the computing device 20 to reach a charging location 50 (310) and adjusting the power consumption policy based on the proximity of the computing device 20 to a charging location being within a predefined distance in accordance with the determined available power or based on the amount of time being within a predefined time in accordance with the determined amount of available power (320). The method may further include determining from the geo-location data a networking signal to connect to (330).

Technical effects and benefits of the present invention include providing a portable computing device with an ability to adjust a power consumption policy in accordance with geo-location data whereby the portable computing device recognizes where it is located, determines its proximity to a charging location and makes decisions as to adjustments of the power consumption policy accordingly so that power can be saved and/or computing operations can be handled most efficiently. Additional benefits include providing the portable computing device with an ability to use the geo-location data to determine which local network to connect to.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A portable computing device, comprising:
a power source for providing a power supply in accordance with a power consumption policy;
a processing unit operably coupled to the power source; and
a storage unit operably coupled to the power source and the processing unit and configured to cause the processing unit to access geo-location data and to adjust the power consumption policy based on the geo-location data.

2. The portable computing device according to claim 1, wherein the geo-location data is provided by a positioning system.

3. The portable computing device according to claim 2, further comprising a built-in device to receive the geo-location.

4. The portable computing device according to claim 2, wherein the geo-location data is received at a proximal device.

5. The portable computing device according to claim 1, wherein the geo-location data is obtained via a wireless protocol.

6. The portable computing device according to claim 1, wherein the power consumption policy is adjustable in response to types of computing operations to be conducted.

7. The portable computing device according to claim 1, wherein the power consumption policy is adjustable in response to power demands of computing operations to be conducted.

8. The portable computing device according to claim 1, the storage unit being further configured to cause the processing unit to access the geo-location data and to determine a networking signal to connect to.

9. The portable computing device according to claim 1, the storage unit being further configured to cause the processing unit to access the geo-location data, determine from the geo-location data whether a prior charging location is within a predefined distance and adjust the power consumption policy in accordance with a result of the determination.

10. The portable computing device according to claim 9, wherein the predefined distance is obtained in accordance with a remainder of the power supply.

11. The portable computing device according to claim 1, the storage unit being further configured to cause the processing unit to access the geo-location data, determine from the geo-location data whether a prior charging location is expected to be reached within a predefined time and adjusts the power consumption policy in accordance with a result of the determination.

12. The portable computing device according to claim 11, wherein the predefined time is obtained in accordance with a remainder of the power supply.

13. A method of managing a power consumption policy of a portable computing device, the method comprising:
determining an amount of available power;
obtaining from geo-location data at least one of a proximity of the computing device to a charging location and an amount of time expected for the computing device to reach a charging location; and
adjusting the power consumption policy responsive to the determined available power and at least one of the proximity of the computing device to a charging location and the expected amount of time for the computing device to reach a charging location.

14. The method according to claim 13, wherein the obtaining comprises receiving the geo-location data provided by a positioning system.

15. The method according to claim 13, wherein the adjusting comprises adjusting the power consumption policy in response to at least one of types of computing operations to be conducted, power demands of computing operations to be conducted and a number of charging locations.

16. The method according to claim 13, further comprising determining from the geo-location data a networking signal to connect to.

17. A computer program product for managing a power consumption policy of a portable computing device, the computer program product comprising:
a tangible storage medium readable by a processing circuit and storing instructions for execution, by the processing circuit, a method comprising:
determining an amount of available power;
obtaining from geo-location data at least one of a proximity of the computing device to a charging location and an amount of time expected for the computing device to reach a charging location; and
adjusting the power consumption policy responsive to the determined available power and at least one of the proximity of the computing device to a charging location and the expected amount of time for the computing device to reach a charging location.

18. The method according to claim 17, wherein the obtaining comprises receiving the geo-location data provided by a positioning system.

19. The method according to claim 17, wherein the adjusting comprises adjusting the power consumption policy in response to at least one of types of computing operations to be conducted, power demands of computing operations to be conducted and a number of charging locations.

20. The method according to claim 17, further comprising determining from the geo-location data a networking signal to connect to.
